(19) United States
(12) Patent Application Publication
(10) Pub. No.: US 2013/0113857 A1
(43) Pub. Date: May 9, 2013

(54) MEDIA TRANSPORT SYSTEM INCLUDING ACTIVE MEDIA STEERING

(71) Applicants: Randy E. Armbruster, Rochester, NY (US); Christopher M. Muir, Rochester, NY (US); Thomas Niertit, Webster, NY (US); Bradley C. DeCook, Rochester, NY (US); Brian J. Joseph, Spencerport, NY (US)

(72) Inventors: Randy E. Armbruster, Rochester, NY (US); Christopher M. Muir, Rochester, NY (US); Thomas Niertit, Webster, NY (US); Bradley C. DeCook, Rochester, NY (US); Brian J. Joseph, Spencerport, NY (US)

(21) Appl. No.: 13/292,117

(22) Filed: Nov. 9, 2011

(51) Int. Cl. B41J 2/01; B41J 29/38

(52) U.S. Cl. 347/16; 347/104; 347/102

(57) ABSTRACT

A digital printing system, for printing on a continuous web of print media, includes a media operation zone in which an operation is performed on the print media. A support structure guides a continuous web of print media under tension through the media operation zone. The support structure includes a first mechanism and a second mechanism. The first mechanism, located upstream relative to the media operation zone, includes structure that positions the print media in a cross track direction so as to establish center justification of the print media as the print media enters the media operation zone. The second mechanism, located downstream relative to the media operation zone, includes structure that positions the print media in a cross track direction so as to maintain center justification of the print media as the print media travels through the media operation zone.

### FIELD OF THE INVENTION

This invention generally relates to a digital printing system for web media and more particularly relates to a media transport system of the printing system that includes an arrangement of components for feeding a continuous web of media from a media supply section through one or more media operation zones in which an operation is performed on the media and to a media take-up section.

### BACKGROUND OF THE INVENTION

Continuous web printing allows economical, high-speed, high-volume print reproduction. In this type of printing, a continuous web of paper or other print media material is fed past one or more printing subsystems that form images by applying one or more colorants onto the print media surface. Proper registration of the print media to the printing device is of considerable importance in print reproduction, particularly where multiple colors are used in four-color printing and similar applications.

The problem of maintaining precise and repeatable web registration and transport becomes even more acute with the development of high-resolution non-contact printing, such as high volume inkjet printing. With this type of printing system, finely controlled dots of ink are rapidly and accurately propelled from the printhead onto the surface of a moving print media, with the web of print media often coursing past the printhead at speeds measured in hundreds of feet per minute. Synchronization and timing are employed to determine the sequencing of colorant application to the moving media. With dot resolution of 600 dots-per-inch (DPI) and better, a high degree of registration accuracy is needed. During printing, variable amounts of ink may be applied to different portions of the rapidly moving print media web, with drying mechanisms typically employed after each printhead or bank of printheads. Variability in ink or other liquid amounts and types or variability in drying times can cause print media stiffness and tension characteristics to vary dynamically for different types of print media, contributing to the overall complexity of print media handling and print media dot registration.

Some digital printing systems including, for example, high volume inkjet printing systems and processes introduce significant moisture content during operation, particularly when the system is used to print multiple colors on a single side of print media or print single or multiple colors on a first side (a front side) of the print media and a second side (a back side) of the print media. Due to changes in its moisture content, the print media expands and contracts (in a cross track direction, an in-track direction, or both) in a non-isotropic manner often with significant hysteresis, a phenomena known as hygroexpansivity. The continual change of dimensional characteristics of the print media often adversely affects dot registration on the print media or adversely affects the alignment of the print media relative to the media transport system of the printing system. The occurrence of either condition may ultimately result in a reduction in print or image quality. While dryers are frequently used to remove the added moisture from the print media, which reverses the moisture-driven expansion of the print media, drying can also cause changes in the dimensional characteristics of the print media that often adversely affects image quality. This is due in part to the drying process removing moisture from the portions of the print media that were not printed on, and also due to the hysteresis inherent in the hygroexpansivity process.

As such, there is an ongoing need to improve the dot registration of patterns printed by these types of digital printing systems. There is also an ongoing need to enhance the print media handling capabilities of these types of printing systems.

### SUMMARY OF THE INVENTION

According to one aspect of the invention, a digital printing system, for printing on a continuous web of print media, includes a media operation zone in which an operation is performed on the print media. A support structure guides a continuous web of print media under tension through the media operation zone. The support structure includes a first mechanism and a second mechanism. The first mechanism, located upstream relative to the media operation zone, includes structure that positions the print media in a cross track direction so as to establish center justification of the print media as the print media enters the media operation zone. The second mechanism, located downstream relative to the media operation zone, includes structure that positions the print media in a cross track direction so as to maintain center justification of the print media as the print media travels through the media operation zone.

According to another aspect of the invention, a method of printing on a continuous web of print media includes providing a digital printing system. The digital printing system includes a media operation zone in which an operation is performed on the print media, and a support structure that guides a continuous web of print media under tension through the media operation zone. The support structure includes a first mechanism and a second mechanism. The first mechanism, located upstream relative to the media operation zone, includes structure that positions the print media in a cross track direction so as to establish center justification of the print media as the print media enters the media operation zone. The second mechanism, located downstream relative to the media operation zone, includes structure that positions the print media in a cross track direction so as to maintain center justification of the print media as the print media travels through the media operation zone. After a print media has been provided, center justification of the print media is established as the print media enters the media operation zone by positioning the print media in a cross track direction using the structure of the first mechanism. Center justification of the print media is maintained as the print media travels through the media operation zone by positioning the print media in a cross track direction using the structure of the second mechanism.

### BRIEF DESCRIPTION OF THE DRAWINGS

In the detailed description of the example embodiments of the invention presented below, reference is made to the accompanying drawings, in which:

FIG. 1 is a schematic side view of a digital printing system according to an example embodiment of the present invention;

FIG. 2 is an enlarged schematic side view of media transport components of the digital printing system shown in FIG. 1;

FIG. 3 is a schematic side view of a large-scale two-sided digital printing system according to another example embodiment of the present invention;

FIG. 4 is a partial schematic top view of some of the components of the digital printing system shown in FIG. 3;

FIG. 5 is a partial schematic side view of some of the media transport components of the digital printing system shown in FIGS. 2 and 3;

FIG. 6 is a partial schematic top view of some of the media transport components of the digital printing system shown in FIGS. 2 and 3;

FIGS. 7-9 are partial schematic perspective views of a portion of one of the media transport components of the digital printing system shown in FIGS. 2 and 3; and

FIG. 10 is a partial schematic top view of some of the components of the digital printing system according to another example embodiment of the present invention.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

The apparatus and method of the present invention are particularly well suited for printing systems that provide non-contact application of ink or other colorant onto a continuously moving medium, for example, a web of print media. The printhead of the present invention selectively moistens at least some portion of the media as it courses through the printing system, but without the need to make contact with the print media.

In the context of the present invention, the term “continuous web of print media” relates to a print media that is in the form of a continuous strip of media as it passes through the printing system from an entrance to an exit thereof. The continuous web of print media itself serves as the receiving print medium to which one or more printing ink or inks or other coating liquids are applied in non-contact fashion. This is distinguished from various types of “continuous webs” or “belts” that are actually transport system components (as compared to the print receiving media) which are typically used to transport a cut sheet medium in an electrophotographic or other printing system. The terms “upstream” and “downstream” are terms of art referring to relative positions along the transport path of a moving web; points on the web move from upstream to downstream.

Additionally, as described herein, the example embodiments of the present invention provide a printing system or printing system components typically used in inkjet printing systems. However, many other applications are emerging which use inkjet printheads to emit liquids (other than inks) that need to be finely metered and deposited with high spatial precision. As such, as described herein, the terms “liquid,” “ink,” “print,” and “printing” refer to any material that can be ejected by the liquid ejector, the liquid ejection system, or the liquid ejection system components described below.

Kinematic web handling is provided not only within each module of the system described below, but also at the interconnections between modules, as the continuously moving web medium passes from one module to another. Unlike a number of conventional continuous web imaging systems, the apparatus described below does not require a slack loop between modules, but typically uses a slack loop only for media that has been just removed from the supply roll at the input end. Removing the need for a slack loop between modules or within a module allows the addition of a module at any position along the continuously moving web, taking advantage of the self-positioning and self-correcting design of media path components. The system described below adapts a number of exact constraint principles to the problem of web handling. As part of this adaptation, techniques have been identified to allow the moving web to maintain proper cross-track registration in a “passive” manner. Steering of the web is avoided; instead, the web's lateral and angular positions in the plane of transport are exactly constrained. Moreover, other web support devices used in transporting the web, other than non-rotating surfaces or those devices purposefully used to exactly constrain the web, are allowed to self-align with the web.

In one example embodiment of the present invention, however, an active steering mechanism is used to determine lateral constraint in order to align or re-align the web span relative to a desired reference point as the web of print media enters and leaves the media operation zone that typically includes one or more printheads for printing on the print media and one or more dryers to dry the ink printed on the print media.

It has been determined that the application of an additional constraint helps maintain registration of the image planes printed by multiple printheads at an acceptable level. Accordingly, one example embodiment of the present invention steers the continuously moving media web, when it is necessary, in order to facilitate acceptable levels of image registration at high transport speeds while reducing the likelihood of damage to the media web or misregistration of liquid, for example, ink or other colorant, applied to the media web.

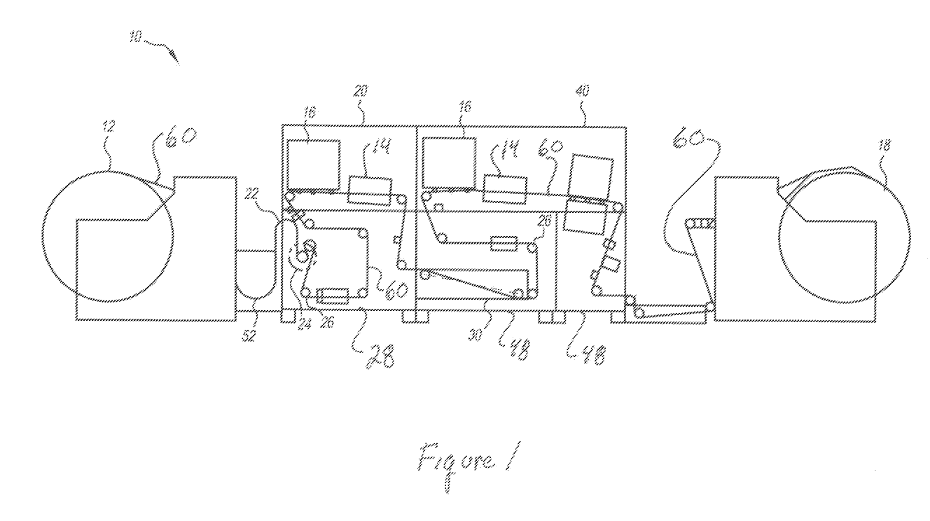

Referring to the schematic side view of FIG. 1, there is shown a digital printing system 10 for continuous web printing according to one example embodiment of the invention. A first module 20 and a second module 40 are provided for guiding continuous web media 60 that originates from a source roller 12. Following an initial slack loop 52, the media 60 that is fed from source roller 12 is then directed through digital printing system 10, past one or more digital printheads 16 and supporting printing system 10 components. First module 20 has a support structure 28 that includes a cross-track positioning mechanism 22 for positioning the continuously moving web of print media 60 in the cross-track direction, that is, orthogonal to the direction of travel and in the plane of travel. In one embodiment, cross-track positioning mechanism 22 is an edge guide for registering an edge of the moving media 60. A tensioning mechanism 24, affixed to the support structure 28 of first module 20, includes structure that sets the tension of the print media 60.

A second module 40, positioned downstream from first module 20 along the path of the continuous web media 60, also has a support structure 48, similar to the support structure 28 for first module 20. Affixed to the support structure 28, 48 of either or both the first or second module 20 or 40 is a kinematic connection mechanism that maintains the kinematic dynamics of the continuous web of print media 60 in traveling from the first module 20 into the second module 40. Also affixed to the support structure 28, 48 of either the first or second module 20 or 40 are one or more angular constraint structures 26 for setting an angular trajectory of the web media 60.

Printing system 10 optionally also includes a turnover mechanism 30 that is configured to turn the media 60 over, flipping it backside-up in order to allow printing on the reverse side as the print media 60 travels through second module 40. When printing is complete, the print media 60 leaves the digital printing system 10 and travels to a media receiving unit, in this case a take-up roller 18. A roll of printed media is then formed, rewound from the printed web of media 60. The digital printing system 10 can include a number of other components, including, for example, multiple print heads and dryers, as described in more detail below. Other examples of digital printing system components include web cleaners, web tension sensors, or quality control sensors.

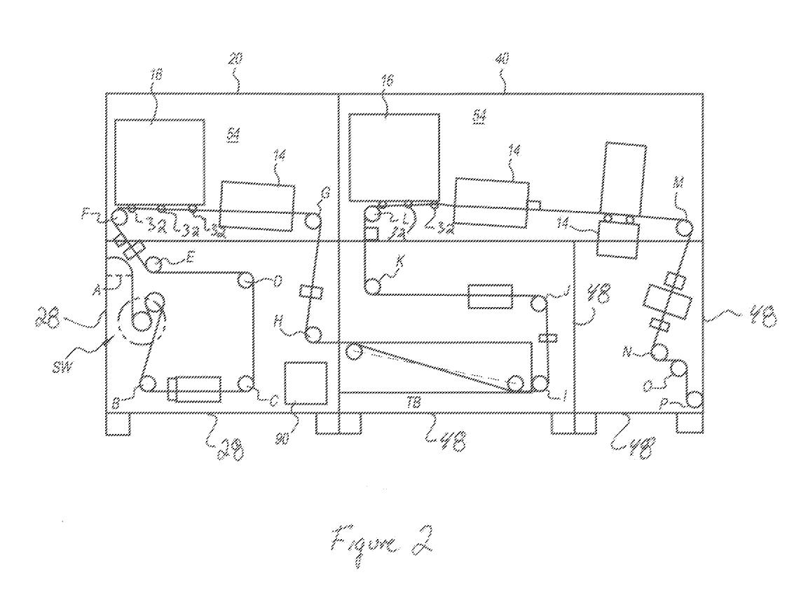

Referring to the schematic side view of FIG. 2, an enlarged view of a portion of the digital printing system 10 of FIG. 1 is shown and includes the media 60 routing path through modules 20 and 40. Within each module 20 and 40, in a print zone 54, a print head 16 is followed by a dryer 14. Optionally, digital printing system 10 can also include other components within either or both of module 20 or module 40. Examples of these types of system components include components for inspection of the print media, for example, components to monitor and control print quality.

Table 1, presented below, identifies the lettered components used for web media transport and shown in FIG. 2. An edge guide in which the media 60 is pushed laterally so that an edge of the media 60 contacts a stop is provided at A. The slack web entering the edge guide allows the print media 60 to be shifted laterally without interference and without being over constrained. An S-wrap device SW provides stationary curved surfaces over which the continuous web slides during transport. As the print media 60, for example, an inkjet paper, is pulled over the surfaces of the S-wrap device SW, the friction of the paper across these surfaces produces tension in the print media 60. In one embodiment, the S-wrap device SW provides an adjustment of the positional relationship between surfaces, to control the angle of wrap and allow adjustment of web tension.

TABLE 1
Roller Listing for FIG. 2

| | Type of Component |
|---|---|
| Media Handling | |
| Component | |
| A | Lateral constraint (edge guide) |
| SW—S-Wrap | Zero constraint (non-rotating support). |
| | Tensioning. |
| B | Angular constraint (in-feed drive roller) |
| C | Zero constraint (Castered and Gimbaled Roller) |
| D* | Angular constraint with hinge (Gimbaled Roller) |
| E | Lateral constraint (edge guide) OR Steered |
| | Angular constraint with hinge (Servo-Caster with |
| | Gimbaled Roller) |
| F | Angular constraint (Fixed Roller) |
| G | Steered Angular constraint with hinge (Servo- |
| | Caster with Gimbaled Roller) |
| H | Angular constraint with hinge (Gimbaled Roller) |
| TB (TURNOVER) | |
| I | Zero constraint (Castered and Gimbaled Roller) |
| J* | Angular constraint with hinge (Gimbaled Roller) |
| K | Lateral constraint (edge guide) OR Steered |
| | Angular constraint with hinge (Servo-Caster with |
| | Gimbaled Roller) |
| L | Angular constraint (Fixed Roller) |
| M | Steered Angular constraint with hinge (Servo- |
| | Caster with |
| | Gimbaled Roller) |
| N | Angular constraint (out-feed drive roller) |
| O | Zero constraint (Castered and Gimbaled Roller) |
| P | Angular constraint with hinge (Gimbaled Roller) |

Note:
Asterisk (*) indicates locations of load cells.

The first angular constraint is provided by in-feed drive roller B. This is a fixed roller that cooperates with a drive roller in the turnover section TB and with an out-feed drive roller N in second module 40 in order to move the web through the printing system with suitable tension in the direction of print media movement or travel (from left to right as shown in FIG. 2). The tension provided by the preceding S-wrap serves to hold the paper against the in-feed drive roll so that a nip roller is not required at the drive roller. Angular constraints at subsequent locations downstream along the web are often provided by rollers that are gimbaled so as not to impose an angular constraint on the next downstream web span.

The media transport system of the example embodiment shown in FIG. 2 includes other components. A lateral constraint mechanism is used at A. Here, at the beginning of the media path, a single edge guide provides lateral constraint for registering the continuous web of print media 60. However, given this lateral constraint and the following angular constraint, the lateral constraint for subsequent web spans can be fixed. In one example embodiment, a gentle additional force is applied along the cross-track direction as an aid for urging, the media 60 edge against the edge guide at A. This force is often referred to as a nesting force as the force helps cause the edge of the media 60 to nest alongside the edge guide. A suitable edge guide is described in commonly-assigned U.S. Patent Application Publication No. US 2011/0129278 A1, published on Jun. 2, 2011, entitled “EDGE GUIDE FOR MEDIA TRANSPORT SYSTEM”, by Muir et al., the disclose of which is incorporated by reference herein in its entirety.

In one example embodiment of the present invention, cross track position of the print media is center justified as it enters the media operating zone. This is done at transport element E either by a passive centering web guide (for example, by a web guide such as is described in commonly-assigned U.S. Pat. No. 5,360,152 entitled “WEB GUIDANCE MECHANISM FOR AUTOMATICALLY CENTERING A WEB DURING MOVEMENT OF THE WEB ALONG A CURVED PATH” by Matoushek, the disclose of which is incorporated by reference herein in its entirety) or by an active centering web guide such as a steered angular constraint with hinge (Servo-Caster with Gimbaled Roller), which is described in more detail below. Fixed rollers at F and L precede printhead(s) 16 in each module 20 and 40, providing the desired angular constraint to the web in each print zone 54. These rollers provide a suitable location for mounting an encoder for monitoring the motion of the media 60 through the printing system 10. Under printheads 16, the print media 60 is supported by fixed non-rotating supports 32, for example, brush bars. Alternatively, fixed rollers can support the paper under the printheads, if the print media has minimal wrap around the rollers. Supports 32 provide minimal constraint to the web.

Printhead 16 prints in response to supplied print data on the print media 60 in the span between roller F and G, which includes the media operation zone. Water-based inks add moisture to the print media, which can cause the print media to expand, especially in the crosstrack direction. The added moisture also lowers the stiffness of the print media. A dryer 14 following the printhead dries the ink, typically by a directing heat and a flow of air at the print media. The dryer drives moisture out of the print media, causing the print media to shrink and its stiffness to change. These changes to the print media in the media operation zone can cause the print media to drift in the crosstrack direction as it passes through the media operation zone. The width of the print media as it leaves the media operation zone can also differ from the width of the print media as it entered the media operation zone. To accommodate these effects, one example embodiment of the present invention includes a steered angular constraint with hinge (a Servo-Caster with Gimbaled Roller) at roller G to center justify the print media as it leaves the media operation zone. Because of the relative length to width ratio of the media 60 in the segment between F and G, the continuous web in that segment is considered to be non-stiff, showing some degree of compliance in the cross-track direction. As a result, the additional constraint provided by the steered angular constrain can be included without over constraining that web segment.

A similar configuration is used in module 40. Accordingly, in one example embodiment of the present invention a steered angular constraint with hinge (a Servo-Caster with Gimbaled Roller) is included at roller M to center justify the print media as it leaves the media operation zone. Roller K includes either a passive web centering guide (for example, the centering guide of U.S. Pat. No. 5,360,152) or an active mechanism such as a steered angular constraint with hinge (Servo-Caster with Gimbaled Roller) to center justify the print media as it enters the media operation zone.

The angular orientation of the print media 60 in the print zone containing one or more printheads and possibly one or more dryers is controlled by a roller placed immediately before or immediately after the print zone. This is critical for ensuring registration of the print from multiple printheads. It is also critical that the web not be over constrained in the print zone. As a result of the transit time of the print drops from the jetting module to the print media 60, variations in spacing of the printhead to the print media 60 from one side of the printhead to the other, it is desirable to orient the printheads parallel to the print media 60. To maintain the uniformity of this spacing between the printhead and the print media 60, preferably the constraint relieving roller placed at one end of the print zone is not free to pivot in a manner that will alter the printhead to print media 60 spacing. Therefore, the castered roller following the print zone should preferably not include a gimbal pivot. However, the use of non-rotating supports 32 under the media 60 in the print zone as shown in FIG. 2 can be used to eliminate this design restriction.

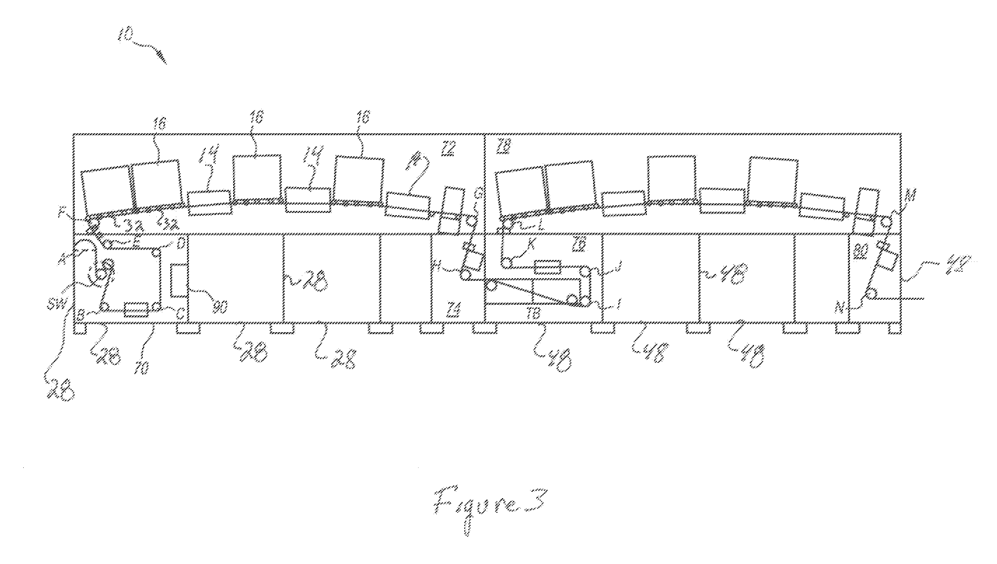

A digital printing system 10 shown schematically in FIG. 3 has a considerably longer print path than that shown in FIG. 2, but provides the same overall sequence of angular constraints, with the same overall series of gimbaled, castered, and fixed rollers. Table 2 lists the roller arrangement used with the system of FIG. 3 for one example embodiment of the invention. Non-rotating supports 32, for example, brush bars, shown between rollers F and G and between L and M in FIG. 3, include non-rotating surfaces and thus apply no lateral or angular constraint forces.

TABLE 2
Roller Listing for FIG. 3

| | Type of Component |
|---|---|
| Media Handling | |
| Component | |
| A | Lateral constraint (edge guide) |
| SW—S-Wrap | Zero constraint (non-rotating support) |
| B | Angular constraint (in-feed drive roller) |
| C | Zero constraint (Castered and Gimbaled Roller) |
| D* | Angular constraint with hinge (Gimbaled Roller) |
| E | Lateral constraint (edge guide) OR Steered |
| | Angular constraint with hinge (Servo-Caster with |
| | Gimbaled Roller) |
| F | Angular constraint (Fixed Roller) |
| G | Steered Angular constraint with hinge (Servo- |
| | Caster with Gimbaled Roller) |
| H | Angular constraint with hinge (Gimbaled Roller) |
| TB (TURNOVER) | |
| I | Zero constraint (Castered and Gimbaled Roller) |
| J* | Angular constraint with hinge (Gimbaled Roller) |
| K | Lateral constraint (edge guide) OR Steered |
| | Angular constraint with hinge (Servo-Caster with |
| | Gimbaled Roller) |
| L | Angular constraint (Fixed Roller) |
| M | Steered Angular constraint with hinge (Servo- |
| | Caster with Gimbaled Roller) |
| N | Angular constraint (out-feed drive roller) |
| O | Zero constraint (Castered and Gimbaled Roller) |
| P | Angular constraint with hinge (Gimbaled Roller) |

Note:
Asterisk (*) indicates locations of load cells.

For the embodiments shown in FIG. 2 and FIG. 3, the pacing drive component of the printing apparatus is the turnover module TB. Turnover module TB is conventional and has been described in commonly-assigned U.S. Patent Application Publication No. US 2011/0128337, published on Jun. 2, 2011, entitled “MEDIA TRANSPORT SYSTEM FOR NON-CONTACT PRINTING”, by Muir et al, the disclosure of which is incorporated by reference herein in its entirety.

Load cells are provided in order to sense web tension at one or more points in the system. In the embodiments shown in FIG. 2 (Table 1) and FIG. 3 (Table 2), load cells are provided at gimbaled rollers D and J. Control logic for the respective digital printing system 10 monitors load cell signals at each location and, in response, makes any needed adjustment in motor torque in order to maintain the proper level of tension throughout the system. There are two tension-setting mechanisms, one preceding and one following turnover module TB. On the input side, load cell signals at roller D indicate tension of the web preceding turnover module TB; similarly, load cell signals at roller J indicate web tension on the output side, between turnover module TB and take-up roll 18. Control logic for the appropriate in- and out-feed driver rollers at B and N, respectively, can be provided by an external computer or processor, not shown in figures of this application. Optionally, an on-board control logic processor 90, such as a dedicated microprocessor or other logic circuit, is provided for maintaining control of web tension within each tension-setting mechanism and for controlling other machine operation and operator interface functions. As described, the tension in a module preceding the turn bar and a module following the turnover module TB can be independently controlled relative to each other further enhancing the flexibility of the printing system. In this example embodiment, the drive motor is included in the turnover module TB. In other example embodiments, the drive motor need not be included in a turnover mechanism. Instead, the drive motor can be appropriately located along the web path so that tension within one module can be independently controlled relative to tension in another module.

The configuration shown in FIGS. 1 and 2 were described as including two modules 20 and 40 with each module providing a complete printing apparatus. However, the “modular” concept need not be restricted to apply to complete printers. Instead, the configuration of FIG. 3 can be considered as including as many as seven modules, as described below.

An entrance module 70 is the first module in sequence, following the media supply roll, as was shown earlier with reference to FIG. 1. Entrance module 70 provides the edge guide A that positions the media 60 in the cross-track direction and provides the S-wrap SW or other appropriate web tensioning mechanism. In the embodiment of FIG. 3, entrance module 70 provides the in-feed drive roller B that cooperates with SW and other downstream drive rollers to maintain suitable tension along the web, as noted earlier. Rollers C, D, and E are also part of entrance module 70 in the FIG. 3 embodiment. Transport element E includes either a passive centering web guide (for example, by a web guide such as is described in commonly-assigned U.S. Pat. No. 5,360,152) or a steered angular constraint with hinge (Servo-Caster with Gimbaled Roller) in order to center justify the print media as it enters the media operation zone. A first printhead module 72 accepts the web media 60 from entrance module 70, with the given edge constraint, and applies an angular constraint with fixed roller F. A series of stationary fixed non-rotating supports 32, for example, brush bars or, optionally, minimum-wrap rollers then transport the web along past a first series of printheads 16 with their supporting dryers 14 and other components. Here, because of the considerable web length in the web segment beyond the angular constraint provided by roller F (that is, the distance between rollers F and G), that segment can exhibit flexibility in the cross track direction which is an additional degree of freedom that may need be constrained. As such, one example embodiment of the present invention includes a steered angular constraint with hinge (a Servo-Caster with Gimbaled Roller) at roller G.

An end feed module 74 provides an angular constraint to the incoming media 60 from printhead module 72 by means of gimbaled roller H. Turnover module TB accepts the incoming media 60 from end feed module 74 and provides an angular constraint with its drive roller, as described above. Optionally, digital printing system 10 can also include other components within any of the modules described above. Examples of these types of system components include components for inspection of the print media, for example, components to monitor and control print quality.

A forward feed module 76 provides a web span corresponding to each of its gimbaled rollers 3 and K. These rollers again provide angular constraint only. The lateral constraint for web spans in module 76 is obtained from the edge of the incoming media 60 itself. Roller K includes either a lateral constraint (for example, an additional edge guide like the one included at roller A) or a steered angular constraint with hinge (Servo-Caster with Gimbaled Roller) in order to maintain the cross-track position of the print media web.

A second printhead module 78 accepts the web media 60 from forward feed module 76, with the given edge constraint, and applies an angular constraint with fixed roller L. A series of stationary fixed non-rotating supports 32, for example, brush bars or, optionally, minimum-wrap rollers then feed the web along past a second series of printheads 16 with their supporting dryers and other components, while providing little or no lateral constraint on the print media. One example embodiment of the present invention includes a steered angular constraint with hinge (a Servo-Caster with Gimbaled Roller) at roller M to center justify the web of print media as it leaves the media operation zone that is located between rollers L and M. Here again, because of considerable web length in the web segment (that is, extending the distance between rollers L and M), that segment can exhibit flexibility in the cross track direction which is an additional degree of freedom enabling the use of the steered angular constraint without over constraining the print media in that span.

An out feed module 80 provides an out-feed drive roller N that serves as angular constraint for the incoming web and cooperates with other drive rollers and sensors along the web media path that maintain the desired web peed and tension. Optional rollers O and P (not shown in FIG. 3) may also be provided for directing the printed web media 60 to an external accumulator or take-up roll.

Each module in this sequence provides a support structure and an input and an output interface for kinematic connection with upstream or downstream modules. With the exception of the first module in sequence, which provides the edge guide at A, each module utilizes one edge of the incoming web media 60 as its “given” lateral constraint. The module then provides the needed angular constraint for the incoming media 60 in order to provide the needed exact constraint or kinematic connection of the web media transport. It can be seen from this example that a number of modules can be linked together using the apparatus and methods of the present invention. For example, an additional module could alternately be added between any other of these modules in order to provide a useful function for the printing process.

When multiple modules are used, as was described with reference to the embodiment shown in FIG. 3, it is important that the system have a master drive roller that is in control of web transport speed. Multiple drive rollers can be used and can help to provide proper tension in the web transport (x) direction, such as by applying suitable levels of torque, for example. In one embodiment, the turnover TB module drive roller acts as the master drive roller. The in-feed drive roller at B in module 72 (or, referring to FIG. 2, module 20) adjusts its torque according to a load sensing mechanism or load cell that senses web tension between the drive and in-feed rollers. Similarly, out-feed drive roller N can be controlled in order to maintain a desired web tension within module 78 (or, referring to FIG. 2, module 40).

As noted earlier, slack loops are not required between or within the modules described with reference to FIG. 3. Slack loops can be appropriate, however, where the continuous web is initially fed from a supply roll or as it is re-wound onto a take-up roll, as was described with reference to the printing system 10 shown in FIG. 1.

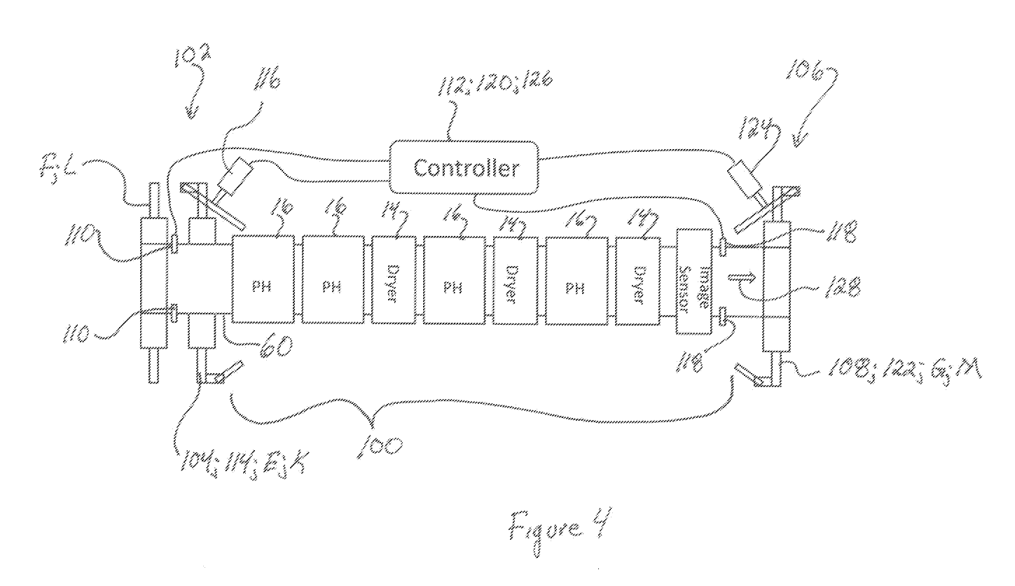

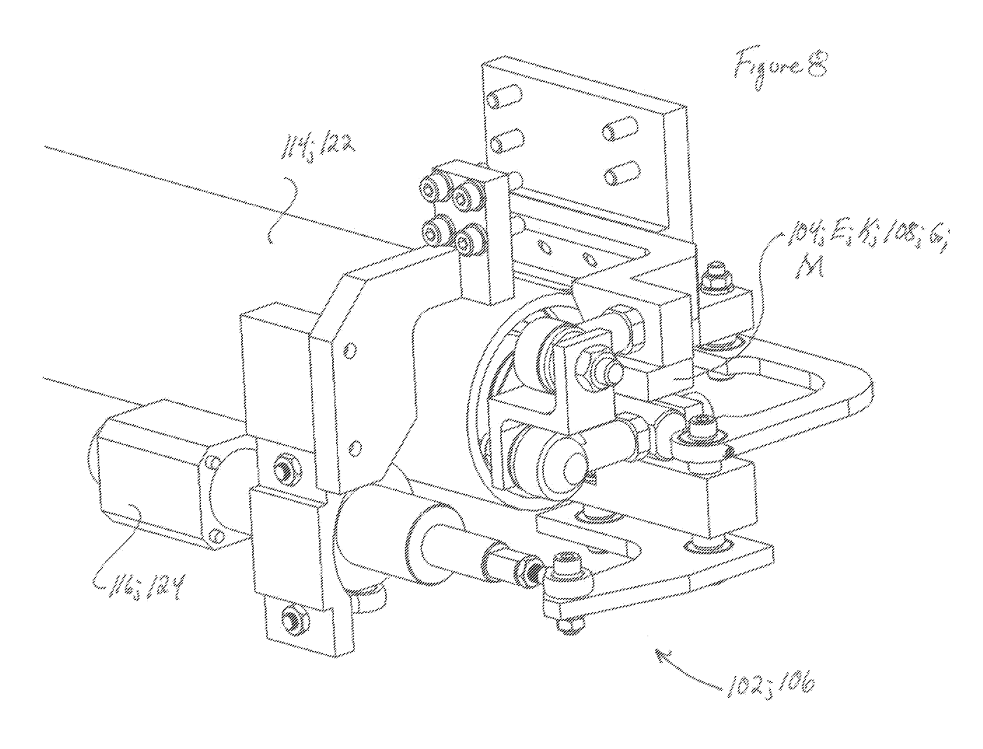

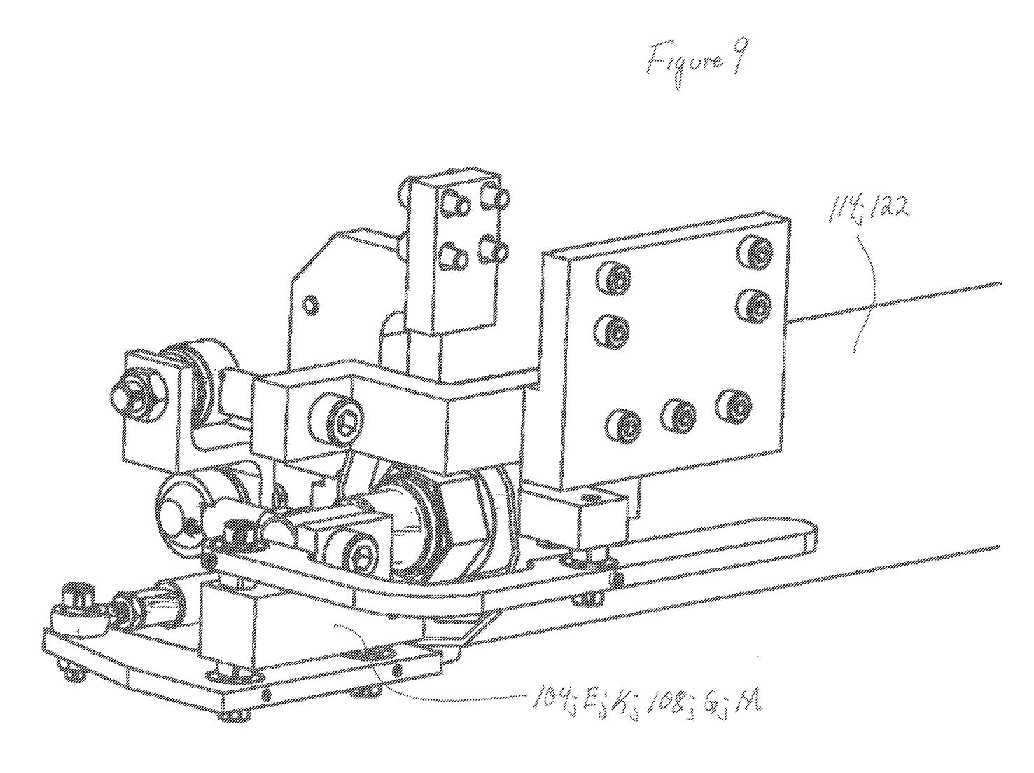

The servo-caster with gimbaled roller example embodiments of the present invention will now be described in more detail with reference to FIGS. 4-9.

Referring to FIGS. 4-6 and back to FIGS. 1-3, generally described, the present invention provides a digital printing system for printing on a continuous web of print media. Printing system 10 includes a media operation zone 100 in which an operation is performed on a print media 60. A support structure 28 or 48 (shown in FIGS. 2 and 3) guides a continuous web of print media 60 under tension through the media operation zone 100. Support structure 28 or 48 includes a first mechanism 102 located upstream relative to the media operation zone 100. First mechanism 102 includes structure 104 that positions the print media 60 in a cross track direction so as to establish center justification of the print media 60 as the print media 60 enters the media operation zone 100. A second mechanism 106, located downstream relative to the media operation zone 100, includes structure 108 that positions the print media 60 in a cross track direction so as to maintain center justification of the print media 60 within the media operation zone 100. In some example embodiments of the invention, structure 108 actively positions the print media 60, for example, by steering the print media 60 in a cross track direction. In other example embodiments of the invention, structure 108 passively positions the print media 60 in a cross track direction, for example, when structure 108 includes the center justifying web guide described in U.S. Pat. No. 5,360,152.

In some example embodiments of the invention, printing system 10 also includes an edge guide that sets an initial cross track position of the print media 60. This edge guide is located upstream relative to first mechanism 102. This edge guide is conventional. One example of a suitable edge guide is described in commonly-assigned U.S. Patent Application Publication No. US 2011/0129278 A1, published on Jun. 2, 2011, entitled “EDGE GUIDE FOR MEDIA TRANSPORT SYSTEM”, by Muir et al., the disclose of which is incorporated by reference herein in its entirety. This edge guide is designed to expand and contract to accommodate different widths of print media in a manner that the centerline of the media doesn't shift significantly in the cross track direction, approximately center justifying the print media. As a result, the print media typically undergoes only minor shifts in crosstrack position when it is center justified by the first mechanism.

The print media 60 includes a structural characteristic that changes, at least temporarily, when the print media 60 is in the media operation zone 100. The print media structural characteristics include, for example, a dimensional characteristic of the print media or a stiffness characteristic of the print media. Typically, the change in the structural characteristic(s) of the print media 60 occurs due to one or a plurality of devices positioned in the media operation zone that change the structural characteristic(s) of the print media 60, at least temporarily, while the print media 60 is in the media operation zone 100. For example, when a portion of the print media 60 is selectively moistened by the device(s), for example, one or a plurality of printheads, the moistened portions of the print media tend to expand, in particular in the crosstrack direction as the print media passes through the media operation zone 100. The selective moistening of portions of the print media also tends to lower the tension in the in-track direction in those portions of the print media. This can cause the print media 60 to drift laterally as it passes through the media operation zone 100. When the device(s) includes a dryer that dries the print media, portions of the print media contract, in particular in the cross track direction, as the print media passes through the media operation zone 100. As the print media is dried by the device(s), portions of the print media that had been selectively moistened contract which tend to increase tension in the in-track direction in these portions of the print media. Additionally, drying of the print media causes the print media to become stiffer in both the in-track and cross track directions, in particular in areas of the print media that had been selectively moistened by, for example, one or a plurality of printheads. This can cause the print media 60 to drift laterally as it passes through the media operation zone 100. Accordingly, the media operation zone begins at the location of the first device that alters, at least temporarily, the structural characteristic(s) of the print media 60 and ends at the location of the last device that alters, at least temporarily, the structural characteristic(s) of the print media 60.

First mechanism 102 and second mechanism 106 help to center justify the print media 60 while the print media 60 is in the media operation zone 100. In this sense, the center line of the print media web is maintained within acceptable tolerances by controlling the cross track position or location of the print media web. Typically, the center line of the print media web is maintained within acceptable tolerances relative to a device that is performing an operation on the print media while the print media is traveling through (located in) the media operation zone 100. In one example embodiment of the present invention, the print media 60 is center justified, rather than edge justified, as it has been found that when the width of the print media changes and the print media is edge justified the registration errors tend to increase from a low level near the edge justification edge to, in some situations, significant registration errors near the print media edge that is opposite the edge of the edge justification. Center justification, by reducing the distance from the line of justification to the distant edge of the print media, produces lower peak levels of registration errors when compared to edge justification. Accordingly, center justification of the print media 60 represents a significant improvement when compared to conventional edge justification of the print media.

Referring back to FIG. 2, in one example embodiment of the present invention, media operation zone 100, located in module 20 or module 40, includes a printhead 16 that is configured to selectively moisten at least a portion of the print media 60 being guided through the media operation zone 100 without contacting the print media 60. As shown in FIG. 2, media operation zone 100 also includes a dryer 14 positioned downstream relative to printhead 16.

Referring back to FIG. 3, in another example embodiment of the present invention, media operation zone 100, located in module 72 or module 78, includes a plurality of printheads 16 configured to selectively moisten at least a portion of the print media 60 being guided through the media operation zone 100 without contacting the print media 60. As shown in FIG. 3, media operation zone 100 also includes a dryer 14 positioned downstream relative to at least one of the plurality of printheads 16. In FIG. 3, for example, a first dryer 14 is positioned downstream from a plurality of adjacent printheads 16 and a second dryer 14 is positioned downstream from a single printhead 16. In this manner, media operation zone, includes a plurality of dryers 14. The media operation zone 100 shown in FIG. 4 includes the module 72 or 78 configuration shown in FIG. 3. It should be understood, however, that the media operation zone 100 configuration shown in FIG. 3 can be readily reconfigured to the one shown in FIG. 2.

First mechanism 102 additionally includes a sensor 110 that senses the cross track position of the print media 60 and communicates with a control system 112 that controls structure 104 to position the print media 60 in a cross track direction based on information received from sensor 110. Sensor 110 is located between structure 104 of first mechanism 102 and media operation zone 100 to provide an accurate measurement of the print media as it enters the media operation zone. Preferably the sensor 110 includes sensing elements positioned on both the first and the second edge of the print media. By means of the sensing elements along both sides (edges) of the print media, the sensor 110 can determine the width of the print media 60 and the crosstrack position of the centerline of the print media. In some embodiments the determination of the width of the print media and the cross track position of the centerline of the print media is carried out within the sensor 110, which sends that information to the control system 120. In other embodiments, the sensor 110 send the position of the first edge and the position of the second edge of the print media to the control system 120, which uses that data to determine of the width of the print media and the cross track position of the centerline of the print media.

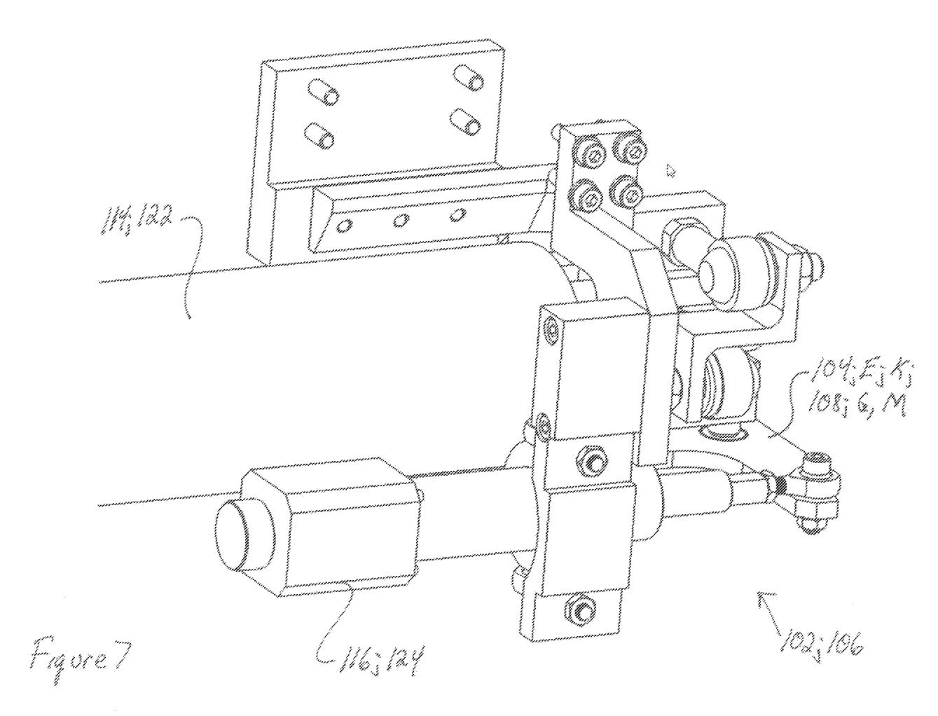

In one example embodiment of structure 104 of first mechanism 102, structure 104 actively positions the print media 60 in a cross track direction so as to establish center justification of the print media 60 as the print media 60 enters the media operation zone 100. To accomplish this, structure 104 includes, for example, a steered caster roller 114 that is rotatable about a caster roller axis. Steering of the caster roller 114 is accomplished by adjustment of an angle of the caster roller about caster axis using, for example, a servo motor 116, shown in more detail in FIGS. 7-9. The configuration of caster roller 114 is conventional. One example of a suitable caster roller 114 configuration is described in commonly-assigned U.S. Patent Application Publication No. US 2011/0129277 A1, published on Jun. 2, 2011, entitled “PUNT MEDIA TENSIONING APPARATUS”, by Muir et al., the disclose of which is incorporated by reference herein in its entirety. Servo motor 116 is also conventional and commercially available, for example, from Ultra Motion, located in Cutchogue, N.Y. Alternatively, any conventional servo motor can be used provided it has the performance characteristics to make it suitable for the type of roller steering contemplated herein.

Optionally, control system 112 includes a low pass filter that filters out localized imperfections in an edge of the print media 60. In some example embodiments of the invention, the low pass filter includes a cut off frequency that is dependent, for example, on the speed of the print media 60 as the print media 60 travels through media operation zone 100 to enable the low pass filter system to filter out localized imperfections having a spatial period down the edge of the print media of less than some critical length, independent of the speed of the print media through the media operation zone.

Alternatively, structure 104 of first mechanism 102 can include a media centering guide to establish center justification of the print media 60 as the print media 60 enters the media operation zone 100. A suitable media centering guide is described in commonly assigned U.S. Pat. No. 5,360,152 entitled “WEB GUIDANCE MECHANISM FOR AUTOMATICALLY CENTERING A WEB DURING MOVEMENT OF THE WEB ALONG A CURVED PATH” by Matoushek, the disclose of which is incorporated by reference herein in its entirety.

Second mechanism 106 additionally includes a sensor 118 that senses the cross track position of the print media 60 and communicates with a control system 120 that controls structure 108 to actively position the print media 60 in a cross track direction based on information received from sensor 118. Sensor 118 is located between structure 108 of second mechanism 106 and media operation zone 100.

In one example embodiment of structure 108, structure 108 includes a steered caster roller 122 that is rotatable about a caster roller axis. Steering of the caster roller 122 is accomplished by adjustment of an angle of the caster roller relative to the caster roller axis using, for example, a servo motor 124, shown in more detail in FIGS. 7-9. The configuration of caster roller 122 is conventional. One example of a suitable caster roller 122 configuration is described in commonly-assigned U.S. Patent Application Publication No. US 2011/0129277 A1, published on Jun. 2, 2011, entitled “PRINT MEDIA TENSIONING APPARATUS”, by Muir et al., the disclose of which is incorporated by reference herein in its entirety. As shown in FIG. 4 and FIGS. 1-3, the structure 108 of second mechanism 106 is located immediately adjacent to media operation zone 100. Servo motor 124 is also conventional and commercially available, for example, from Ultra Motion, located in Cutchogue, N.Y. Alternatively, any conventional servo motor can be used provided it has the performance characteristics to make it suitable for the type of roller steering contemplated herein.

Control system 112 of first mechanism 102 and control system 120 of second mechanism 106 can be included in the same control system, for example, controller 126 shown in FIG. 4. Controller 126 can be incorporated into on-board control logic processor 90, described above. Alternatively, controller 126 can be an external computer or processor that is distinct from processor 90.

Control system 112 of first mechanism 102 and control system 120 of second mechanism 106 can also be maintained as separate and distinct computers or processors. In this configuration, sensor 110 of first mechanism 102 is a first sensor and control system 112 of first mechanism 102 is a first control system. Sensor 118 of second mechanism 106 is a second sensor and control system 120 of second mechanism 106 is a second control system that controls the structure that positions the print media in a cross track direction based on information received from the second sensor. In certain embodiments, at least one of the first control system and the second control system is responsive to information received from both the first sensor and the second sensor so as to maintain the cross track position of the print media 60 while the print media 60 is traveling through (or located in) the media operation zone 100.

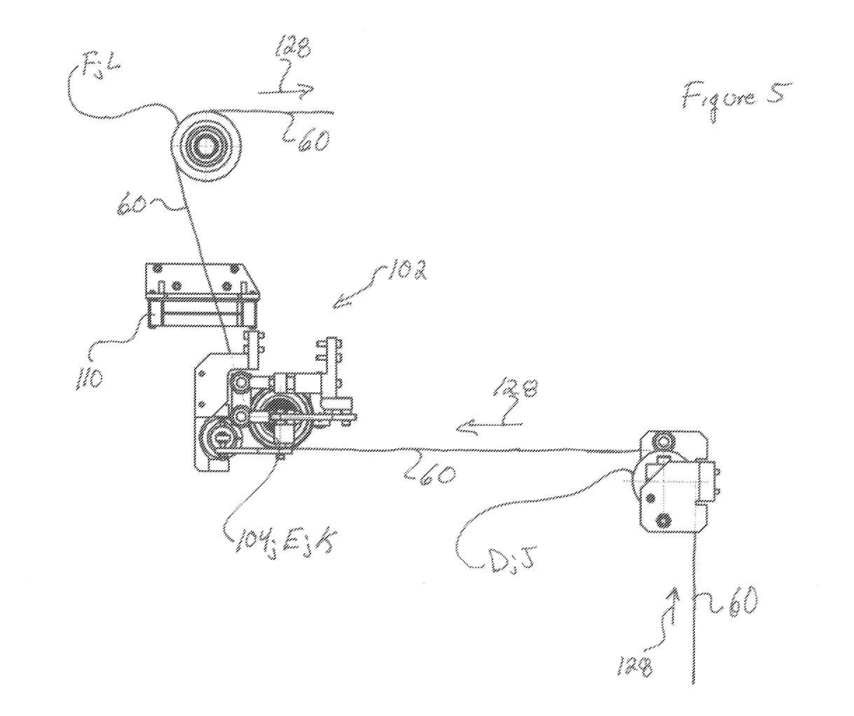

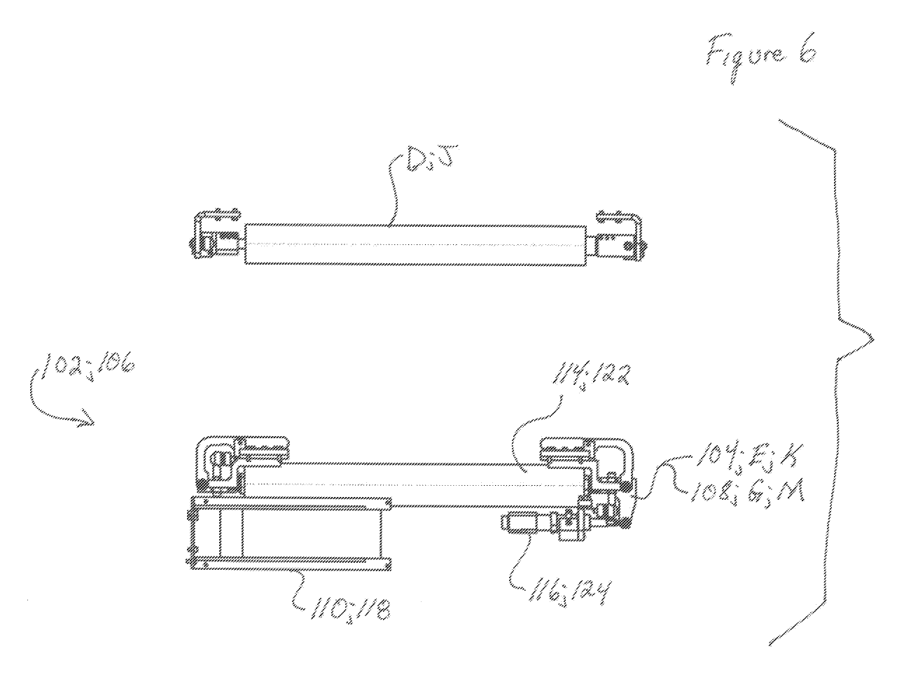

Referring to FIGS. 5 and 6 and back to FIG. 4, a partial schematic side view and a partial schematic top view that include an example embodiment of first mechanism 102 is shown. First mechanism 102 includes structure 104, servo motor 116, and sensor 110. As shown, structure 104 is configured to include caster roller 114 with gimbal like the one described above. The fixed roller positioned at roller location F or roller location L and the gimbal roller positioned at roller location D or J are also shown in FIGS. 5 and 6. As shown in FIGS. 5 and 6, sensor 110 is positioned on a first edge of the print media 60 (the left hand edge of the print media as shown in FIGS. 5 and 6 as viewed along a direction of print media travel represented by arrow 128). Sensor 110, however, can be located on either edge of the print media 60. As such, sensor 110 can be positioned on a second edge of the print media 60 (the right hand edge of the print media as shown in FIGS. 5 and 6 as viewed along a direction of print media travel represented by arrow 128).

Sensor 110 senses the cross track position of the print media 60 and sends this information to control system 112. Depending on the information received by control system 112, if it is necessary control system 112 steers caster roller 114 using servo motor 116 to adjust a location of caster roller 114 through linkage connected to an arm that is responsive to servo motor 116 to adjust the position the print media 60 in a cross track direction. Sensor 110 is located between structure 104 of first mechanism 102 and media operation zone 100. Referring additionally back to FIGS. 2 and 3, the example embodiment of first mechanism 102 shown in FIGS. 4-6 is located in roller locations E, K, or both E and K. As shown in FIGS. 5 and 6, sensor 110 is a conventional print media edge sensor and sensor 110 is located along the travel path of print media 60 between roller location E or K and roller location F or L, respectively. Sensor 110 is positioned downstream from roller location E or K, for example, downstream from caster roller 114.

When structure 104 includes the edge guide described above, sensor 110 is not needed in all example embodiments of the present invention because the edge guide component of the media transport system is aligned (for example, center justified) with the media operation zone 100 of the printing system.

An example embodiment of second mechanism 106 is configured in the same manner as that of the example embodiment of first mechanism 102 shown in FIGS. 5 and 6. Second mechanism 106 includes structure 108, servo motor 124, and sensor 118. As shown, structure 108 is configured to include caster roller 122 with gimbal like the one described above. Like sensor 110, sensor 118 can be positioned on a first edge of the print media 60 (the left hand edge of the print media as shown in FIGS. 5 and 6 as viewed along a direction of print media travel represented by arrow 128). Sensor 118, however, can be located on either side of the print media 60. As such, sensor 118 can be positioned on a second edge of the print media 60 (the right hand edge of the print media as shown in FIGS. 5 and 6 as viewed along a direction of print media travel represented by arrow 128). Preferably the sensor 118 includes sensing elements positioned on both the first and the second edge of the print media. By means of the sensing elements along both sides (edges) of the print media, the sensor 118 can determine the width of the print media 60 and the crosstrack position of the centerline of the print media. In some embodiments the determination of the width of the print media and the cross track position of the centerline of the print media is carried out within the sensor 118, which sends that information to the control system 120. In other embodiments, the sensor 118 send the position of the first edge and the position of the second edge of the print media to the control system 120, which uses that data to determine of the width of the print media and the cross track position of the centerline of the print media.

Sensor 118 is located between structure 108 of second mechanism 104 and media operation zone 100 to provide an accurate measurement of the crosstrack position of the print media as it leaves the media operation zone 100. In an alternate embodiment, the sensor is located between the final device that acts on the print media in the media operation zone and the structure 108. Referring additionally back to FIGS. 2 and 3, the example embodiment of second mechanism 104 shown in FIGS. 4-6 is located in roller locations G, M, or both G and M. When second mechanism 104 is configured as shown in FIGS. 5 and 6, sensor 118 is a conventional print media edge sensor and sensor 118 is located along the travel path of print media 60 in media operation zone 100 and upstream from roller location G or M, for example, upstream from caster roller 122. In some embodiments, the spacing between the sensing elements of sensor 118 is adjustable to accommodate different widths of print media. Preferably the width adjustment hardware adjusts the position of both the sensing element on the first edge and the sensing element on the second edge so that both sensors are symmetrically positioned about the desired centerline of the print media.

Depending on the information received by control system 120, if it is necessary, control system 120 steers caster roller 122 using servo motor 124 to adjust a location of caster roller 122 through linkage connected to an arm that is responsive to servo motor 116 to adjust the position the print media 60 in a cross track direction. In this manner, the second mechanism 106 controls the crosstrack position of the print media 60 in such a way that the crosstrack position of the centerline of the print media doesn't drift, even when the width of the print media varies as a result of the operation of one or more device on the print media as the print media passes through the media operation zone 100 As such the second mechanism center justifies the print media, maintaining the centerline of the print media at a fixed position in the cross track direction in spite of changes in the print media width.

Center justifying the print media at each end of the media operation zone by means of the first mechanism and the second mechanism of the invention helps to improve the color to color registration of images or documents printed by printheads located within the media operation zone. As mentioned earlier, the print media can change width and can also drift in the crosstrack direction as a result of the action of one or more devices within the media operation zone. In prior art digital printing systems, having multiple printheads in a print zone, a drift in the crosstrack position of the print media as it moves from the beginning to the end of the print zone can cause the print of the latter printheads in the print zone to be misregistered relative to the print of the first printhead in the print zone. The invention by controlling the crosstrack position of the print media at the beginning and end of the media operation zone reduces these registration errors.

The invention furthermore center justifies the print media by means of the first mechanism and the second mechanism. As a result, the centerline of the print media doesn't drift in the crosstrack direction as it passes through the media operation zone, even if the print media expands or shrinks in the crosstrack direction. The expansion or shrinkage of the print media in the crosstrack direction can still produce varying amounts of crosstrack registration errors of the image planes across the width of the print media. As the invention reduces or eliminates the drift in the crosstrack position of the centerline of the print media, the crosstrack registration errors produced by the crosstrack expansion or shrinkage of the print media invention are near zero at or near to the centerline of the print media and they get progressively larger on both sides of the centerline. Compared to a system that keeps an edge of the print media from drifting in the crosstrack direction rather than the centerline, the invention cuts the peak misregistration errors by approximately 50%.

Referring to FIGS. 7-9, perspective views of first mechanism 102 or second mechanism 106 made in accordance with one example embodiment of the present invention are shown. First mechanism 102 includes structure 104 and servo motor 116. As shown, structure 104 is configured to include caster roller 114 with gimbal like the one described above. Second mechanism 106 includes structure 108 and servo motor 124. As shown, structure 108 is configured to include caster roller 122 with gimbal like the one described above. Referring additionally back to FIGS. 2 and 3, the example embodiment of first mechanism 102 shown in FIGS. 7-9 is located in roller locations E, K, or both E and K. The example embodiment of second mechanism 106 shown in FIGS. 7-9 is located in roller locations G, M, or both G and M.

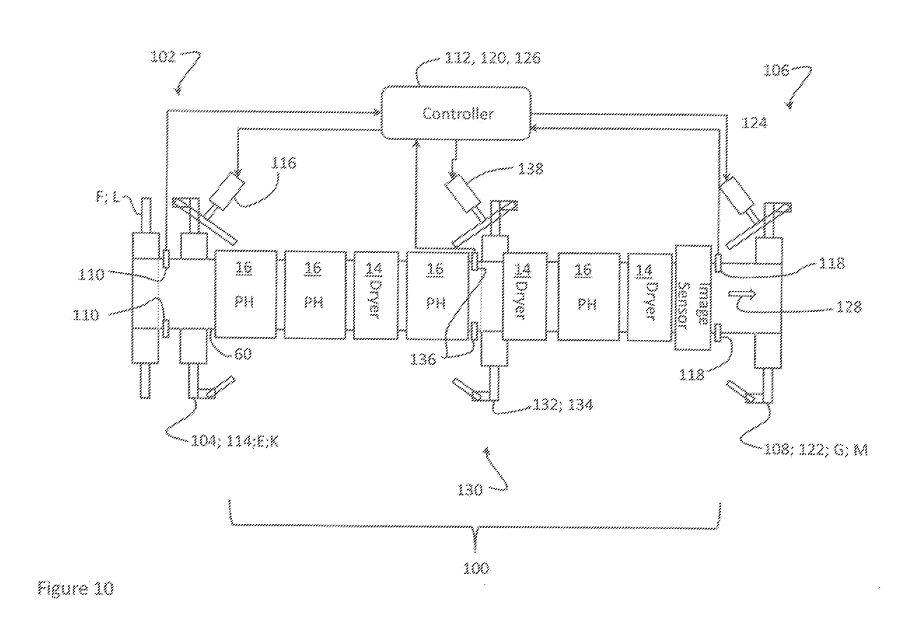

FIG. 10 illustrates another embodiment of the invention. As shown, the digital printing system includes third mechanism 130 for center justifying the print media 60 at an intermediate location in the media operation zone 100 in addition to the first mechanism 102 and the second mechanism 106, which center justify the print media 60 at the beginning and the end of the media operation zone. The third mechanism includes a structure 132 that positions the print media 60 in a cross track direction so as to establish center justification of the print media at a location in the media operation zone intermediate to the locations of the first mechanism and the second mechanism. The structure 132 of the third mechanism can comprise a steered caster roller 134 as has been described above. The third mechanism can include a sensor 136 that senses the cross track position of the print media; and the control system controls the servo motor 138 that steers the steered caster roller 134 to position the print media in a cross track direction based on information received from the sensor 136. Preferably the sensor comprises sensing elements to detect the crosstrack position of the first edge of the print media and to detect the crosstrack position of the second edge of the print media, so that the crosstrack position of the centerline of the print media can be determined at an intermediate location within the media operation zone. Based on the output of the sensor 136, the third mechanism adjusts the position of the centerline of the print media at an intermediate location in the media operation zone to center justify the print media at this intermediate location so that the centerline of the print media at this intermediate location doesn't drift in the crosstrack direction.

It has been found that web transports systems as described above maintain effective control of the print media 60 in the context of a digital print system where the selected portions of the print media 60 are moistened in the printing process. This is true even when the print media 60 is prone to expanding in length and width and to becoming less stiff when it is moistened, for example, for cellulose based print media 60 moistened by water based ink. This enables the individual color planes of a multi-colored document to be printed with good registration to each other. Accordingly, the web transport arrangements described above provide acceptable registration and repeatable performance at high speeds commensurate with the requirements of high-speed color inkjet printing. As has also been described above, multiple modules can be integrated to form printing system 10, without the requirement for painstaking alignment of rollers or other media handling components at the interface between two modules.

An example embodiment of printing on a continuous web of print media using the present invention will now be described. A digital printing system is provided which includes a media operation zone in which an operation is performed on the print media, and a support structure that guides a continuous web of print media under tension through the media operation zone. The support structure includes a first mechanism and a second mechanism. The first mechanism, located upstream relative to the media operation zone, includes structure that positions the print media in a cross track direction so as to establish center justification of the print media as the print media enters the media operation zone. The second mechanism, located downstream relative to the media operation zone, includes structure that positions the print media in a cross track direction so as to maintain center justification of the print media as the print media travels through the media operation zone. After a print media has been provided, center justification of the print media is established as the print media enters the media operation zone by positioning the print media in a cross track direction using the structure of the first mechanism. Center justification of the print media is maintained as the print media travels through the media operation zone by positioning the print media in a cross track direction using the structure of the second mechanism.

The print media includes a structural characteristic and during printing an operation is performed on the print media while the print media is in the media operation zone using a device that at least temporarily changes the structural characteristic of the print media. When the device includes a printhead, the operation includes selectively moistening of portions of the print media using the printhead. When the device includes a dryer, the operation includes drying the portions of the print media that have been moistened using the dryer.

While the invention has been described in the context of a digital printing having a media transport with exact constraints for guiding the print media to and from the media operation zone, the invention can also be effectively used in digital printing systems having conventional media transports. The invention can also be effectively employed in the digital printing module of a larger printing system that can include digital printing portions and analog printing (such as offset, gravure, or flexographic) portions.

The invention has been described in detail with particular reference to certain preferred embodiments thereof, but it will be understood that variations and modifications can be effected within the scope of the invention.

### PARTS LIST

10. Printing system
12. Source roller
14. Dryer
16. Digital printhead
18. Take-up roll
20. Module
22. Cross-track positioning mechanism
24. Tensioning mechanism
26. Constraint structure
28. Support structure
30. Turnover mechanism
32. Fixed non-rotating supports
40. Module
48. Support structure
52. Slack loop
54. Print zone
60. Web of print media
70. Entrance module
72. Module
74. End feed module
76. Forward feed module
78. Module
80. Out-feed module
90. Control logic processor
100. Media operation zone
102. First mechanism
104. Structure
106. Second mechanism
108. Structure
110. Sensor
112. Control system
114. Caster roller
116. Servo motor
118. Sensor
120. Control system
122. Caster roller
124. Servo motor
126. Controller
128. Print media travel direction
130. Third mechanism
132. Structure
134. Caster roller
136. Sensor
138. Servo motor
B, C, D, E, F, G, H, I, J, K, L, M, N, O, P. Rollers
SW. S-wrap
TB. Turnover module

1. A digital printing system for printing on a continuous web of print media comprising:
a media operation zone in which an operation is performed on the print media; and
a support structure that guides a continuous web of print media under tension through the media operation zone, the support structure including:
a first mechanism located upstream relative to the media operation zone, the first mechanism including structure that positions the print media in a cross track direction so as to establish center justification of the print media as the print media enters the media operation zone; and
a second mechanism located downstream relative to the media operation zone, the second mechanism including structure that positions the print media in a cross track direction so as to maintain center justification of the print media as the print media travels through the media operation zone.

2. The digital printing system of claim 1, the media operation zone comprising:
a printhead that is configured to selectively moisten at least a portion of the print media being guided through the media operation zone without contacting the print media.

3. The digital printing system of claim 1, the media operation zone comprising:
a plurality of printheads configured to selectively moisten at least a portion of the print media being guided through the media operation zone without contacting the print media.

4. The digital printing system of claim 3, the media operation zone further comprising:
a dryer positioned downstream relative to at least one of the plurality of printheads.

5. The digital printing system of claim 1, wherein the second mechanism includes structure that actively positions the print media in a cross track direction so as to maintain center justification of the print media within the media operation zone.

6. The digital printing system of claim 5, the digital printing system including a control system configured to control the structure of the second mechanism, the second mechanism further comprising:
a sensor that senses the cross track position of the print media and communicates with the control system such that the control system positions the print media in a cross track direction based on information received from the sensor.

7. The digital printing system of claim 6, wherein the sensor of the second mechanism is positioned upstream relative to the structure of the second mechanism.

8. The digital printing system of claim 5, wherein the structure of the second mechanism includes a steered caster roller.

9. The digital printing system of claim 8, the caster roller being rotatable about a caster axis, wherein the caster roller is steered by adjustment of an angle of the caster roller relative to the caster axis.

10. The digital printing system of claim 9, further comprising:
a servo motor that adjusts the angle of the caster roller relative to the caster axis.

11. The digital printing system of claim 6, the control system including a low pass filter that filters out localized imperfections in an edge of the print media.

12. The digital printing system of claim 11, the low pass filter including a cut off frequency, wherein the cut off frequency of the low pass filter depends on the speed of the print media as the print media travels through the media operation zone.

13. The digital printing system of claim 1, wherein the first mechanism includes structure that actively positions the print media in a cross track direction so as to establish center justification of the print media as the print media enters the media operation zone.

14. The digital printing system of claim 13, the digital printing system including a control system configured to control the structure of the first mechanism, the first mechanism further comprising:
a sensor that senses the cross track position of the print media and communicates with the control system such that the control system positions the print media in a cross track direction based on information received from the sensor.

15. The digital printing system of claim 14, wherein the sensor of the first mechanism is located downstream relative to the structure of the first mechanism.

16. The digital printing system of claim 13, wherein the structure of the first mechanism includes a steered caster roller.

17. The digital printing system of claim 5, the first mechanism including structure that actively positions the print media in a cross track direction so as to establish center justification of the print media as the print media enters the media operation zone, the digital printing system further comprising:
a control system configured to control the structure of the second mechanism and control the structure of the first mechanism;
the first mechanism further comprising:
a first sensor that senses the cross track position of the print media and communicates with the control system, the sensor of the first mechanism being positioned upstream relative to the media operation zone;
the second mechanism further comprising:
a second sensor that senses the cross track position of the print media and communicates with the control system, the sensor of the second mechanism being positioned downstream relative to the media operation zone;
wherein the control system is configured to control the structure of the second mechanism to actively position the print media in a cross track direction in response to information received from both of the first sensor and the second sensor.

18. The digital printing system of claim 1, further comprising:
a print media centering web guide configured to set an initial cross track position of the print media, the print media centering web guide being located upstream relative to the first mechanism.

19. The digital printing system of claim 1, wherein the second mechanism is located immediately adjacent to the media operation zone.

20. The digital printing system of claim 1, the print media including a structural characteristic, wherein the structural characteristic of the print media changes in the media operation zone.

21. The digital printing system of claim 20, further comprising:
a plurality of devices that change the structural characteristic of the print media when the print media is in the media operation zone.

22. The digital printing system of claim 2, the media operation zone further comprising:
a dryer positioned downstream relative to the printhead.

23. The digital printing system of claim 1, further comprising:
a third mechanism positioned at an intermediate location of the media operation zone and between the first mechanism and the second mechanism, the third mechanism including structure that positions the print media in a cross track direction so as to maintain center justification of the print media as the print media travels through the intermediate location of the media operation zone.

24. A method of printing on a continuous web of print media comprising:
providing a digital printing system including:
a media operation zone in which an operation is performed on the print media; and
a support structure that guides a continuous web of print media under tension through the media operation zone, the support structure including:
a first mechanism located upstream relative to the media operation zone, the first mechanism including structure that positions the print media in a cross track direction so as to establish center justification of the print media as the print media enters the media operation zone; and
a second mechanism located downstream relative to the media operation zone, the second mechanism including structure that positions the print media in a cross track direction so as to maintain center justification of the print media as the print media travels through the media operation zone;
providing a print media;
establishing center justification of the print media as the print media enters the media operation zone by positioning the print media in a cross track direction using the structure of the first mechanism; and
maintaining center justification of the print media as the print media travels through the media operation zone by positioning the print media in a cross track direction using the structure of the second mechanism.

25. The method of claim 24, the print media including a structural characteristic, the method further comprising:
performing an operation on the print media while the print media is in the media operation zone using a device that at least temporarily changes the structural characteristic of the print media.

26. The method of claim 25, the device including a printhead, wherein the operation includes selectively moistening of portions of the print media using the printhead.

27. The method of claim 26, the device including a dryer, wherein the operation includes drying the portions of the print media that have been moistened using the dryer.
